(19) United States
(12) Patent Application Publication
(10) Pub. No.: US 2015/0287143 A1
(43) Pub. Date: Oct. 8, 2015

(54) SYSTEM AND METHOD FOR MANAGING UNDERWRITING USING A RISK ORDER APPROACH

(71) Applicant: John Hancock Life Insurance Company (U.S.A.), Boston, MA (US)

(72) Inventors: Matthew F. Gabriel, Boston, MA (US); Daragh O'Sullivan, Boston, MA (US)

(21) Appl. No.: 14/678,605

(22) Filed: Apr. 3, 2015

Related U.S. Application Data
(60) Provisional application No. 61/974,868, filed on Apr. 3, 2014.

(51) Int. Cl. G06Q 40/08

(52) U.S. Cl. CPC G06Q 40/08

(57) ABSTRACT

The disclosed technology relates generally to a method and system for assessing the eligibility of a customer to receive insurance from a provider. In certain embodiments, the disclosed technology uses a risk order approach to rank applicants based on mortality. Applicants are evaluated based on the impact a variety of metrics have on mortality and the system determines a recommended risk class and policy terms for each applicant. The system, in certain embodiments, provides a modular underwriting platform that is expandable and able to incorporate several underwriting tools (e.g., lab scores, market view data). The modular structure of the platform enables the system to be adjusted such that the approach may be modified for use in new insurance markets. In certain implementations, the system provides the ability to make slight adjustments to allow for preferred class distinctions in a simplified issue context.

### BACKGROUND

Underwriters are responsible for assessing the risk of providing insurance to applicants. Underwriters determine whether an insurance company should provide insurance to an applicant and the terms of the policy based on the applicant's information. The underwriter must analyze several risk factors and determine how each risk factor is relevant to the requested policy. For example, the underwriter of a business insurance policy may consider whether and when a particular event (e.g., a bankruptcy) has occurred and how the applicant's situation (e.g., financial situation) has changed since the event occurred. Based on this analysis, the underwriter will decide whether to offer the requested insurance policy to the applicant, and, if so, the appropriate premiums and amounts of coverage.

In doing so, the underwriter must achieve a balance between being overly cautious and too risky. If the underwriter takes on too much risk, the insurance company will pay too many claims. On the other hand, if an underwriter is too risk adverse, the insurance company will not make enough money from premium payments because applicants will be unlikely to accept the offered terms.

Many underwriters employ a set of knock-out criteria to separate risks into preferred risk classes. The knock-out approach applies a set of criteria for each risk class. An applicant is “knocked-out” of a preferred class if they do not satisfy the given criteria. For example, an applicant may not qualify for a particular risk class if they do not meet one or more cutoff levels for a set of criteria associated with the particular risk class. However, the current knockout approach to preferred underwriting does not provide an accurate classification of all risks. There is a need for improved systems and methods of assisting underwriters in assessing eligibility for an insurance product using an approach that provides a more accurate classification of risks and greater flexibility for preferred class distinctions.

### SUMMARY

The disclosed technology relates generally to a method and system for assessing the eligibility of a customer to receive insurance from a provider. The insurance may be, for example, term life insurance, universal life insurance, variable life insurance, or long term care insurance. In certain embodiments, the disclosed technology uses a risk order approach to rank applicants based on mortality. Applicants are evaluated based on the impact a variety of metrics have on mortality and the system determines a recommended risk class and policy terms for each applicant. For example, for a given life insurance applicant, a hazard ratio is determined for each of a plurality of criteria, and a final (composite) hazard ratio is determined that accounts for all of the criteria, including interaction between the criteria. The final hazard ratio is then used to determine the recommended risk class and/or policy terms for a given applicant.

In particular, it is found that the traditional knock-out underwriting approach over-emphasizes a potential insured's worst criteria and fails to capture true risk of mortality over the insured population. In contrast, the risk order approach described herein provides a more holistic, more efficient, and fairer underwriting scheme than the traditional knockout approach.

Furthermore, the system, in certain embodiments, provides a modular underwriting platform that is expandable and able to incorporate several underwriting tools (e.g., lab scores and market view data). The modular structure of the platform enables the system to be adjusted such that the approach may be modified for use in new insurance markets. Furthermore, the system may be adapted to allow for preferred distinctions on a continuous spectrum, rather than a predetermined number of discrete classes.

In one aspect, the invention is directed to a method for assessing eligibility for an insurance product using a risk order approach, the method comprising: receiving, by a processor of a computing device, one or more inputs associated with an applicant for use in determining an underwriting decision; storing, by the processor, in a database, (i) the one or more inputs and (ii) a unique identifier associated with the applicant and the one or more inputs; providing, by the processor, for display on a graphical user interface of a second computing device associated with an underwriter, underwriting data, wherein the underwriting data is based at least in part on the one or more inputs; receiving, by the processor, from the second computing device, a request to determine the underwriting decision; determining, by the processor, a hazard ratio for each member of a plurality of criteria based at least in part on the underwriting data; determining, by the processor, a final hazard ratio based at least in part on the hazard ratio for each member of the plurality of criteria; determining, by the processor, the underwriting decision based at least in part on the final hazard ratio; and providing, by the processor, for display on a graphical user interface of the second computing device, the underwriting decision.

In certain embodiments, the method comprises, after providing underwriting data for display on a graphical user interface of the second computing device, receiving, by the processor, an instruction to overwrite at least a portion of the underwriting data. In certain embodiments, the method comprises determining, by the processor, that a user associated with the instruction to overwrite at least a portion of the underwriting data satisfies a permission level requirement; and overwriting, by the processor, at least a portion of the underwriting data. In certain embodiments, the method comprises, after providing underwriting data for display on a graphical user interface of the second computing device, receiving, by the processor, an explanation for the instruction to overwrite at least a portion of the underwriting data.

In certain embodiments, the method comprises, after providing the underwriting decision for display on a graphical user interface of the second computing device, receiving, by the processor, an instruction to overwrite the underwriting decision. In certain embodiments, the method comprises, after providing the underwriting decision for display on a graphical user interface of the second computing device, receiving, by the processor, an explanation for the instruction to overwrite the underwriting decision.

In certain embodiments, the one or more inputs comprise at least one member selected from the group consisting of: policy creation date, date of birth, gender, BMI build, blood pressure, motor vehicle record data, non-medical history, tobacco use, personal history, family history, lab results, and health style data.

In certain embodiments, the one or more inputs comprise a date of birth, gender, BMI build, blood pressure, motor vehicle record data, non-medical history, tobacco use, personal history, family history, lab results, and health style data.

In certain embodiments, the underwriting decision comprises a rate structure. In certain embodiments, the underwriting decision comprises a premium amount and/or a coverage amount.

In certain embodiments, the one or more inputs are received from the second computing device. In certain embodiments, the method comprises providing, by the processor, for display on a graphical user interface of the second computing device, information explaining the underwriting decision. In certain embodiments, the information explaining the underwriting decision comprises a comparison of applicant's hazard ratio relative to his/her peers. In certain embodiments, the information explaining the underwriting decision comprises one or more reasons codes that explain the basis for the underwriting decision.

In certain embodiments, the plurality of criteria comprise body mass index, blood pressure (e.g., systolic blood pressure, diastolic blood pressure, and/or treated blood pressure), motor vehicle record (e.g., accidental death, driving while intoxicated, and recklessness), family history, personal history, tobacco use, lab results, health style, and non-medical history (e.g., aviation, hazardous sports, avocation, and other dangerous activities).

In certain embodiments, determining the final hazard ratio comprises identifying an interaction factor, α, and using α in a computation of the final hazard ratio, where α accounts for interactions between and/or among the plurality of criteria. In certain embodiments, the final hazard ratio is determined according to the formula:

α(HR₁*HR₂* . . . *HRₙ)+(1−α)(HR₁+HR₂+ . . . +HRₙ−n)

where n is the number of the plurality of criteria, HRᵢ is hazard ratio for criterion i, and α is the interaction factor.

In certain embodiments, the underwriting decision identifies a risk class for the applicant. In certain embodiments, the risk class is identified from among a predetermined set of risk classes. In certain embodiments, the set of risk classes comprises a preferred class and a standard class. In certain embodiments, the set of risk classes comprises a standard class, a ‘standard plus’ class, a preferred class, and a ‘super preferred’ class (e.g., at least four different levels). In certain embodiments, the predetermined set of risk classes has a unique corresponding pre-determined rate structure.

In certain embodiments, the underwriting decision identifies a premium amount. In certain embodiments, the underwriting decision identifies a coverage amount.

In certain embodiments, the insurance product is a life insurance product. In certain embodiments, the insurance product is a long term care insurance product.

In another aspect, the invention is directed to a system for assessing eligibility for an insurance product using a risk order approach, the system comprising: a memory storing instructions thereon; and a processor for executing the instructions, wherein the instructions comprise: receiving one or more inputs associated with an applicant for use in determining an underwriting decision; storing, in a database, (i) the one or more inputs and (ii) a unique identifier associated with the applicant and the one or more inputs; providing, for display on a graphical user interface of a second computing device associated with an underwriter, underwriting data, wherein the underwriting data is based at least in part on the one or more inputs; receiving, from the second computing device, a request to determine the underwriting decision; determining a hazard ratio for each member of a plurality of criteria based at least in part on the underwriting data; determining a final hazard ratio based at least in part on the hazard ratio for each member of the plurality of criteria; determining the underwriting decision based at least in part on the final hazard ratio; and providing, for display on a graphical user interface of the second computing device, the underwriting decision.

In certain embodiments, the instructions comprise: after providing underwriting data for display on a graphical user interface of the second computing device, receiving an instruction to overwrite at least a portion of the underwriting data. In certain embodiments, the instructions comprise: determining that a user associated with the instruction to overwrite at least a portion of the underwriting data satisfies a permission level requirement; and overwriting at least a portion of the underwriting data. In certain embodiments, the instructions comprise: after providing underwriting data for display on a graphical user interface of the second computing device, receiving an explanation for the instruction to overwrite at least a portion of the underwriting data.

In certain embodiments, the instructions comprise: after providing the underwriting decision for display on a graphical user interface of the second computing device, receiving an instruction to overwrite the underwriting decision. In certain embodiments, the instructions comprise: after providing the underwriting decision for display on a graphical user interface of the second computing device, receiving an explanation for the instruction to overwrite the underwriting decision.

In certain embodiments, the one or more inputs comprise at least one member selected from the group consisting of: policy creation date, date of birth, gender, BMI build, blood pressure, motor vehicle record data, non-medical history, tobacco use, personal history, family history, lab results, and health style data.

In certain embodiments, the one or more inputs comprise a date of birth, gender, BMI build, blood pressure, motor vehicle record data, non-medical history, tobacco use, personal history, family history, lab results, and health style data.

In certain embodiments, the underwriting decision comprises determination of a risk class. In certain embodiments, the risk class is determined from among a predetermined set of risk classes. In certain embodiments, the set of risk classes comprises a preferred class and a standard class. In certain embodiments, the set of risk classes comprises a standard class, a ‘standard plus’ class, a preferred class, and a ‘super preferred’ class (e.g., at least four different levels). In certain embodiments, the predetermined set of risk classes has a unique corresponding pre-determined rate structure.

In certain embodiments, the underwriting decision comprises determination of a premium amount. In certain embodiments, the underwriting decision comprises determination of a coverage amount.

In certain embodiments, the one or more inputs are received from the second computing device. In certain embodiments, the instructions comprise: providing, for display on a graphical user interface of the second computing device, information explaining the underwriting decision. In certain embodiments, the information explaining the underwriting decision comprises a comparison of applicant's hazard ratio relative to his/her peers. In certain embodiments, the information explaining the underwriting decision comprises one or more reasons codes that explain the basis for the underwriting decision.

In certain embodiments, the plurality of criteria comprises body mass index, blood pressure (e.g., systolic blood pressure, diastolic blood pressure, and/or treated blood pressure), motor vehicle record (e.g., accidental death, driving while intoxicated, and recklessness), family history, personal history, tobacco use, lab results, health style, and non-medical history (e.g., aviation, hazardous sports, avocation, and other dangerous activities).

In certain embodiments, determining the final hazard ratio comprises identifying an interaction factor, α, and using α in a computation of the final hazard ratio, where α accounts for interactions between and/or among the plurality of criteria. In certain embodiments, the final hazard ratio is determined according to the formula:

α(HR₁*HR₂* . . . *HRₙ)+(1−α)(HR₁+HR₂+ . . . +HRₙ−n)

where n is the number of the plurality of criteria, HRᵢ is hazard ratio for criterion I, and α is the interaction factor.

In certain embodiments, the insurance product is a life insurance product. In certain embodiments, the insurance product is a long term care insurance product.

In another aspect, the invention is directed to a method for assessing eligibility for an insurance product using a risk order approach, the method comprising: determining, by a processor of a computing device, a hazard ratio for each of a plurality of criteria based at least in part on data (e.g., underwriting data) associated with an applicant; determining, by the processor, a final hazard ratio, wherein the final hazard ratio is a function of the hazard ratios corresponding to the plurality of criteria and an interaction factor α accounting for interaction between and/or among the plurality of criteria; determining, by the processor, an underwriting decision based on the final hazard ratio; and providing, by the processor, the underwriting decision for display on a graphical user interface.

In certain embodiments, the plurality of criteria comprises one or more members (e.g., 5 or more members, 6 or more members, 7 or more members, 8 or more members, or all 9 members) selected from the group consisting of body mass index, blood pressure, motor vehicle record, family history, personal history, tobacco use, lab results, health style, and non-medical history. In certain embodiments, the plurality of criteria comprises one or more activities of daily living (e.g., bathing, continence, dressing, eating, toileting, and/or transferring), fragility, and/or cognitive impairment, e.g., where the insurance product is a long term care insurance product.

In certain embodiments, the insurance product is a life insurance product. In certain embodiments, the insurance product is a long term care insurance product.

In certain embodiments, determining the underwriting decision comprises identifying a risk class for the applicant from among a predetermined set of risk classes. In certain embodiments, the predetermined set of risk classes comprises a standard class and a preferred class. In certain embodiments, the predetermined set of risk classes comprises a standard class, a ‘standard plus’ class, a preferred class, and a ‘super preferred’ class (e.g., at least four different levels). In certain embodiments, each of the predetermined set of risk classes has a unique corresponding pre-determined rate structure.

In certain embodiments, the plurality of criteria comprises at least 5 members (e.g., there are at least 5 criteria, e.g., 5, 6, 7, 8, 9, 10, 11, or 12 criteria) and α is empirically determined (e.g., as opposed to being directly determined from a medical study investigating an interaction between specific criteria).

In certain embodiments, the final hazard ratio is determined according to the formula:

α(HR₁*HR₂* . . . *HRₙ)+(1−α)(HR₁+HR₂+ . . . +HRₙ−n)

where n is the number of the plurality of criteria, HRᵢ is hazard ratio for criterion i, and α is the interaction factor. In certain embodiments, n is no less than 5 (e.g., there are at least 5 criteria, e.g., 5, 6, 7, 8, 9, 10, 11, or 12 criteria) and wherein α is empirically determined (e.g., as opposed to being directly determined from a medical study investigating an interaction between specific criteria).

In certain embodiments, determining the underwriting decision comprises identifying a rate structure based on the final hazard ratio (e.g., identifying a rate structure based directly on the final hazard ratio without first identifying a discrete risk class).

In another aspect, the invention is directed to a system for assessing eligibility for an insurance product using a risk order approach, the system comprising: a memory storing instructions thereon; and a processor for executing the instructions, wherein the instructions comprise: determining a hazard ratio for each of a plurality of criteria based at least in part on data (e.g., underwriting data) associated with an applicant; determining a final hazard ratio, wherein the final hazard ratio is a function of the hazard ratios corresponding to the plurality of criteria and an interaction factor α accounting for interaction between and/or among the plurality of criteria; determining an underwriting decision based on the final hazard ratio; and providing the underwriting decision for display on a graphical user interface.

In certain embodiments, the plurality of criteria comprises one or more members (e.g., 5 or more members, 6 or more members, 7 or more members, 8 or more members, or all 9 members) selected from the group consisting of body mass index, blood pressure, motor vehicle record, family history, personal history, tobacco use, lab results, health style, and non-medical history. In certain embodiments, the plurality of criteria comprises one or more activities of daily living (e.g., bathing, continence, dressing, eating, toileting, and/or transferring), fragility, and/or cognitive impairment, e.g., where the insurance product is a long term care insurance product.

In certain embodiments, the insurance product is a life insurance product. In certain embodiments, the insurance product is a long term care insurance product.

In certain embodiments, determining the underwriting decision comprises identifying a risk class for the applicant from among a predetermined set of risk classes. In certain embodiments, the predetermined set of risk classes comprises a standard class and a preferred class. In certain embodiments, the predetermined set of risk classes comprises a standard class, a ‘standard plus’ class, a preferred class, and a ‘super preferred’ class (e.g., at least four different levels). In certain embodiments, each of the predetermined set of risk classes has a unique corresponding pre-determined rate structure.

In certain embodiments, the plurality of criteria comprises at least 5 members (e.g., there are at least 5 criteria, e.g., 5, 6, 7, 8, 9, 10, 11, or 12 criteria) and α is empirically determined (e.g., as opposed to being directly determined from a medical study investigating an interaction between specific criteria).

In certain embodiments, the final hazard ratio is determined according to the formula:

α(HR₁*HR₂* . . . *HRₙ)+(1−α)(HR₁+HR₂+ . . . +HRₙ−n)

where n is the number of the plurality of criteria, HRᵢ is hazard ratio for criterion i, and α is the interaction factor. In certain embodiments, n is no less than 5 (e.g., there are at least 5 criteria, e.g., 5, 6, 7, 8, 9, 10, 11, or 12 criteria) and wherein α is empirically determined (e.g., as opposed to being directly determined from a medical study investigating an interaction between specific criteria).

In certain embodiments, determining the underwriting decision comprises identifying a rate structure based on the final hazard ratio (e.g., identifying a rate structure based directly on the final hazard ratio without first identifying a discrete risk class).

In various embodiments, elements or features described with respect to one aspect of the invention can be used with respect to another aspect of the invention. Furthermore, in certain embodiments, the described elements or features can be variously combined.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a diagram illustrating an example system for assessing an applicant's eligibility for a product, in accordance with an illustrative embodiment;

FIG. 2 is a flowchart of an example method for assessing an applicant's eligibility for a product, in accordance with an illustrative embodiment;

FIG. 3 is a diagram illustrating an example underwriting process, in accordance with an illustrative embodiment;

FIG. 4 shows a block diagram of an exemplary cloud computing environment used in illustrative embodiments; and

FIG. 5 is a block diagram of a computing device and a mobile computing device used in illustrative embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The disclosed technology, in some implementations, relates generally to a method and system for assessing the eligibility of a customer to receive insurance, for example, life insurance. In certain embodiments, the disclosed technology uses a risk order approach for underwriting, ranking applicants based on mortality. Traditionally, a “knockout” underwriting approach determines that an applicant fails to qualify for a particular preferred risk class (is “knocked out” of the preferred class) if he or she does not meet the cutoff levels for any of a full set of criteria evaluated for that applicant. The resulting assigned risk class is the highest class for which all criteria are met. It is presently found that this approach over-emphasizes a potential insured's worst criteria and fails to capture true risk of mortality over the insured population. In contrast, the risk order approach described herein provides a more holistic, more efficient, and fairer underwriting scheme than the traditional knockout approach.

In certain embodiments, applicants are evaluated based on the impact a variety of criteria have on mortality, and the system determines a recommended risk class for each applicant. In other embodiments, for example, for long term care insurance, the disclosed technology uses a risk order approach, ranking applicants based on likelihood the insured will require substantial assistance with a particular number (one, two, three, or more) of activities of daily living and/or that they will suffer a severe cognitive impairment within a given covered period.

In certain embodiments, there are a predetermined number of risk classes available. For example, there may be a standard risk class and a preferred risk class, where members of the preferred risk class, as a whole, represent a group whose risk of mortality (or other covered event/condition) within a given covered period is likely to be lower than members of the ‘standard’ risk class. In certain embodiments, there are multiple, tiered classes for applicants, for example, three, four, or more classes, ranked according to risk of mortality (or other covered event/condition) within a given covered period. For example, an embodiment in which there are four classes may have a ‘standard’ class, a ‘standard plus’ class, a ‘preferred’ class, and a ‘super preferred’ class, each subsequent class representing a likely lower mortality (or other covered event/condition).

In addition to, or alternatively to, risk class, in certain embodiments, the system determines certain other insurance policy features available to each applicant, e.g., amount of premiums, an applicable rate structure, and/or availability of options such as premium guarantees, conversion privileges, upgrade privileges, and the like, based on risk of mortality or other covered event/condition. The system, in certain embodiments, provides a modular underwriting platform that enables the system to be adjusted such that the approach may be modified for use in new insurance markets. Furthermore, the system may be adapted to allow for preferred distinctions on a continuous spectrum, rather than a predetermined number of discrete classes.

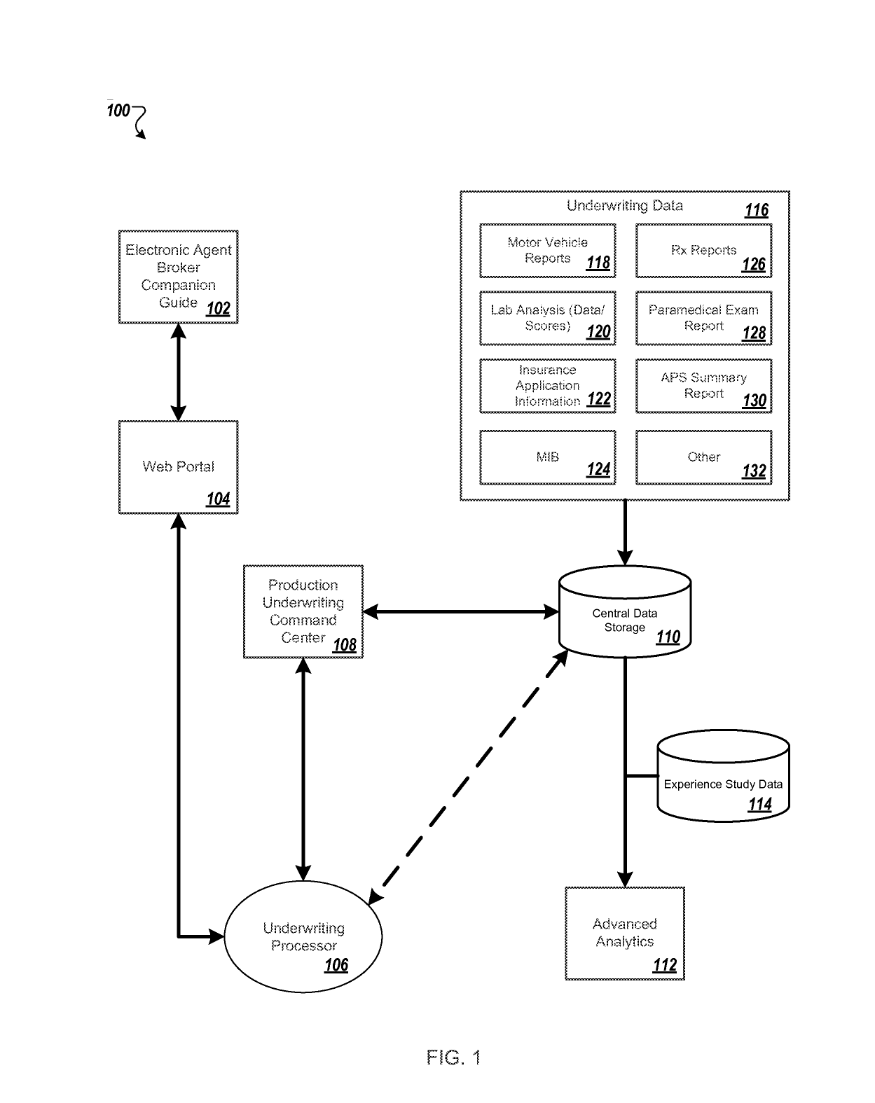

FIG. 1 is a diagram illustrating an example system 100 for assessing an applicant's eligibility for life insurance. In some implementations, the system 100 includes an electronic agent broker companion guide 102 that provides access (e.g., via a web portal 104) to all or part of a grading model (e.g., underwriting processor 106) for assessing applicant eligibility. Underwriters may use the system 100 to assess an applicant's eligibility for insurance and determine the appropriate premium, rate structure, risk class, and/or coverage. In addition, the electronic agent broker companion guide 102 may provide a way for producers to obtain an underwriting decision (e.g., in a test case) based on the underwriting processor 106 without specifying an applicant. For example, a user enters any information (possibly on a simplified basis) and results may not be tied to a specific applicant.

In some implementations, the disclosed technology includes an underwriting processor 106 that implements the grading model using a series of table lookups, conditional logic, and arithmetic to score each applicant. A risk class may be assigned based on the applicant's final score. The grading model may use a set of criteria (e.g., nine) to determine an applicant's score. The criteria may include BMI/build (e.g., based on BMI as determined by Applicant's height and weight), blood pressure (systolic blood pressure, diastolic blood pressure, treated blood pressure), accidental death—MVR/DWI/Recklessness (e.g., based on applicant's motor vehicle record (MVR)), non-medical history (e.g., based on the application and other underwriting discoveries), tobacco use (e.g., based on the application and potentially the lab results for nicotine), personal history (e.g., based on personal health history collected from various sources), family history (e.g., relationship, condition, and severity), lab results (e.g., based on results from blood and urine samples collected), and/or health styles (e.g., based on lifestyle information collected from various sources).

A hazard ratio(s) may be calculated for an applicant based on the criteria. The hazard ratio(s) capture(s) the relative mortality for the applicant due to each of the criteria, respectively. In some implementations, after determining a hazard ratio for each of the criteria, a final hazard ratio is determined based on the hazard ratios for each of the criteria. In some cases, there will not be a hazard ratio for one or more of the criteria. In these cases, a table of default calculation hazard ratios may be used. The default calculation hazard ratios may vary based on gender, age, and individual criteria.

In some implementations, information about the final hazard ratio may be displayed. This information may be used by an underwriter to interpret the output from the grading model. In some implementations, reason codes are provided to help explain the final underwriting decision to the underwriter.

In some implementations, the underwriting processor is in communication with a central data storage system 110. The central data storage system 110 may store underwriting data 116 including, but not limited to, information regarding applicants (e.g., potentially insured). The underwriting data 116 may include motor vehicle reports 118, lab analysis (data/scores) 120, insurance application information 122, MIB 124, prescription history reports 126, paramedical exam reports 128, APS summary reports 128, as well as other information 132 regarding applicants. Underwriting data 116 may be obtained directly from the provider. When necessary, the underwriting data 116 may be manually entered.

Each applicant is uniquely identified in the central data storage system 110, e.g., secured storage. Data may be stored in real time, or a weekly batch process and/or an event driven process may be used, for example.

The data stored in the central data storage system 110 may include the final values of all input fields for the grading model, case status, case starting date, all information tied to the audit trail for a case (e.g., saved interim values for all input fields, who changed them, and the explanation, number of underwriters that make changes to a case, their user IDs, and access level, number of times the same case was assessed by the tool, any tentative decisions, and time stamps associated with the preceding values), overrides used, by whom, and the explanation recorded, final decision, date of final decision, the calculated variables (e.g., for criteria discussed above), and the grading model version.

The central data storage system 110 may allow for ad-hoc querying by an underwriting and/or project research team for grading model oversight. This may include the ability to access all underwriting data available beyond just the grading model inputs. The central data storage system 110 may be connected to claims experience systems for mortality/lapse assumption development. The information stored in the central data storage system 110 may be used to assist in claims adjudication and predictive modeling.

In some implementations, the system 100 includes a production underwriting command center 108 that provides and manages the graphical user interface that underwriters will use to interact with the underwriting processor 106 (e.g., grading model). In some implementations, the production underwriting command center 108 presents underwriting data 116 in a format that allows underwriters to, for example, review it for reasonability and input additional information. Underwriters may need the flexibility to overwrite values obtained electronically before applying the grading model and record an explanation for audit/oversight purposes. After the grading model is applied, the underwriter may review the outcomes and overwrite the decision provided by the grading model.

The level of detail and extent of overrides may vary for each criteria assessed by the model. Overrides may be subject to permission levels. The permission levels may be tightly controlled, but adaptable. In some implementations, all permission level assignments will require the approval of the chief underwriter or his/her designee. In one example there are three permission levels. The highest permission level may be limited to the most senior members of the underwriting staff. The second level may be granted to all production underwriters. It may include the functionality described below for the third level as well as certain override capabilities. The third level may be granted to non-underwriting user of the grading model (e.g., data input specialists).

In some implementations, all users of the system will be granted, at a minimum, third level access. This may include the ability to override electronically pre-populated data fields. When changing pre-populated fields the user may be prompted for an explanation which should be recorded and available at the case level as well as information regarding the time of the change, the user who made the change, and the previous value.

In some implementations, users with second level access will be provided with all level three permissions plus access to certain override switches. Second level switches may set a criteria's hazard ratio equal to that criteria's averages. Users with first level access, in some implementations, will be provided with second level and third level permissions, plus the ability to grant exceptions in a case, reduce impact of criteria, and increase impact of criteria (e.g., by amount or percentage). Users may be prompted to provide an explanation which should be recorded and available at the case level.

For example, consider a scenario involving a chief underwriter, medical director, or senior underwriter with first level access. This individual reviews a case and determines that the additional mortality assigned to a specific insured is not in line with expectations. For example, the specific case does not fit into the grading model, and the underwriter wishes to assign additional mortality to the insured, yet still maintain a ‘standard or better’ decision. In this case, the system allows the senior underwriter to increase the impact of a particular criteria, and the affected hazard ratio(s) are recalculated accordingly.

In another example, consider a scenario involving an underwriter with second level access. The underwriter has evidence that suggest there is no additional risk from an underweight insured. Under second level access, the underwriter can prevent this insured from being penalized by activating his second level access for build. When selecting the hazard ratio for the build of this insured, the grading model logic will point to a different table that includes the average hazard ratios by age and gender, excluding additional hazard for build.

In another example, consider a scenario involving a data specialist with third level access. The data specialist is tasked with entering data into the grading model. The specialist returns to the task realizing he/she has previously made an incorrect entry. The specialist is able to correct his/her input error and is prompted to explain the reason for the change.

In certain embodiments, the system provides for a ‘best class’ entry that allows an underwriter to select the best risk class that the proposed insured would be eligible to receive given the current criteria under review. For example, if the ‘best class’ entry is ‘Standard’, then the final decision will be restricted to Standard (at best) regardless of the grading model result.

In some implementations, the system 100 includes an advanced analytics module 112. The advanced analytics module 112 may be used to create and provide automated reports using the underwriting data. For example, the advanced analytics module 112 may include an advanced statistics package that provides the ability to quickly identify frequency distributions, manipulate data, perform quality control, perform binning, perform advanced statistical analysis and regressions ranging from OLS to more advanced survival models and decision trees, and perform programming and/or calculation development that will allow for actuarial/underwriting grading model modifications to be studied and tested without reliance on excel models. The advanced analytics module 112 may provide data visualization functionality and report automation that can be developed by actuarial and technical underwriting functions, yet allows for senior management review and drill down. The advanced analytics module 112 may also be used for research and development, audit reports, and experience studies. For example, Experience study data 114 may be used to develop and refine the mortality/lapse assumptions used in the grading model. Additionally, the data may be used to assist in claims adjudication and predicative modeling.

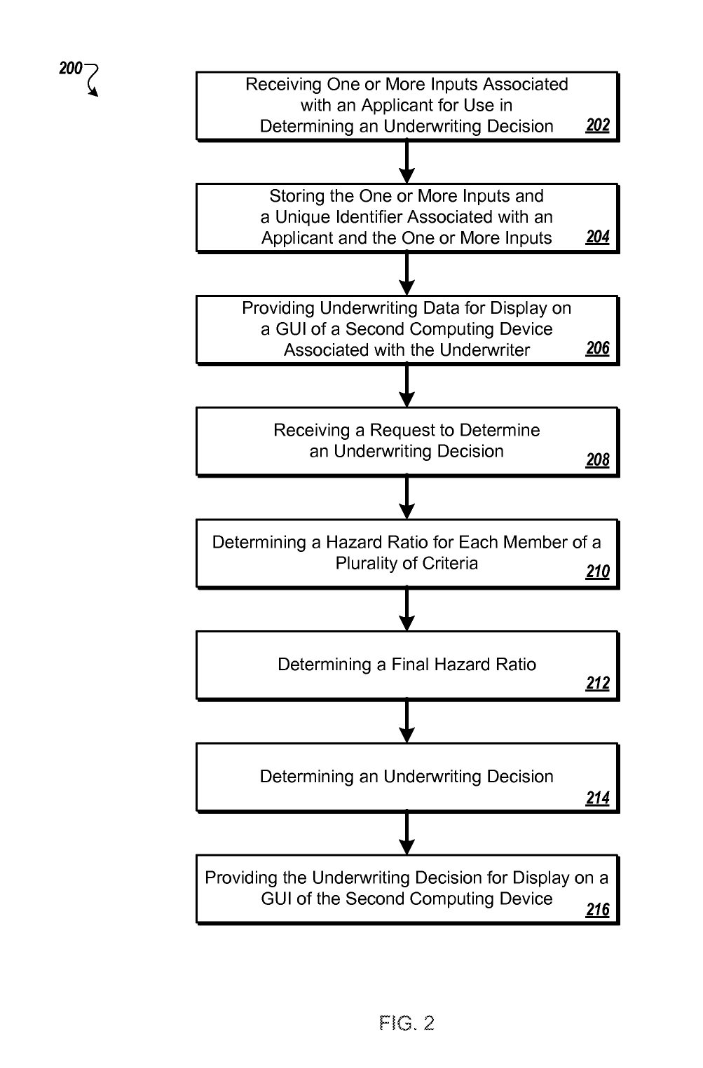

FIG. 2 is a flowchart of an example method 200 for assessing an applicant's eligibility for an insurance product using a risk order approach. The method 200 may include receiving, by a processor of a computing device, one or more inputs associated with an applicant for use in determining an underwriting decision (202). The inputs may include a policy creation date, date of birth, gender, BMI build, blood pressure, motor vehicle record data, non-medical history, tobacco use, personal history, family history, lab results, and/or health style data. Example health style data may be, for example, whether the insured has routine doctor visits, has routine exercise, does not have a family member with functional or cognitive impairment before a particular age, has a college education, has had one or more bankruptcies, has a normal EKG, has a normal routine screening colonoscopy, has a normal screening mammogram, has a normal pap test, has had a normal chest CT scan within a certain time period, has a normal CBC, and/or has normal LFTs and KFTs. The inputs may be received from an underwriter via a computing device or the inputs may be received from a third party, such as a Department of Motor Vehicles, healthcare professional, etc. In some implementations, inputs associated with an applicant are received from different sources. In certain implementations, override permission levels are granted on certain inputs depending on the predetermined access level of the underwriter, as discussed above.

The inputs and a unique identifier associated with the applicant and the one or more inputs may be stored in a database (204). The method 200 may include providing, for display on a graphical user interface of an underwriter's computing device associated with an underwriter, underwriting data (206). The underwriting data may be based in part on the one or more inputs. After reviewing the underwriting data, an underwriter may request to overwrite at least a portion of the underwriting data. In some cases, an underwriter may wish to overwrite the underwriting data (e.g., one of the one or more inputs). The system may determine whether the underwriter satisfies a permission level requirement. If the underwriter has the appropriate permission level, the system may overwrite at least a portion of the underwriting data. After providing underwriting data for display on a graphical user interface of the underwriter's computing device, the system may receive an explanation for the instruction to overwrite at least a portion of the underwriting data.

The method 200 may include receiving a request to determine the underwriting decision (208). The request may be received from the underwriter (e.g., the computing device associated with the underwriter. The system may determine a hazard ratio for each member of a plurality of criteria based at least in part on the underwriting data (210). The criteria may include body mass index, blood pressure (e.g., systolic blood pressure, diastolic blood pressure, and/or treated blood pressure), motor vehicle record (e.g., accidental death, driving while intoxicated, and recklessness), family history, personal history, tobacco use, lab results, health style, and/or non-medical history (e.g., aviation, hazardous sports, avocation, and other dangerous activities). Furthermore, in certain embodiments in which the insurance product is a long term care insurance product, the criteria may include activities of daily living (e.g., bathing, continence, dressing, eating, toileting, and transferring), fragility, and/or cognitive impairment.

A final hazard ratio may be determined based at least in part on the hazard ratio for each member of the plurality of criteria (212) and the underwriting decision for the applicant may be determined based at least in part on the final hazard ratio (214). The underwriting decision may identify a risk class for the applicant, a premium amount, a rate structure, and/or a coverage amount. For example, in certain embodiments, a risk class is assigned based on where the final hazard ratio for a potential insured falls in relation to predetermined cutoff points associated with each of the available risk classes.

Mortality studies performed by the medical community may form the basis for the determination of a hazard ratio for each member of the plurality of criteria. A proportional hazards model may be used, e.g., a generalized linear model in which the hazard ratios for given criteria are constant multiples of baseline hazard ratios. There are various combination approaches to account for multiple criteria. For example, individual hazard ratios can be multiplied, disregarding interactions between criteria (multiplicative approach). This is in line with the basic theory of proportional hazards models. However, disregarding interaction factors may double-count the mortality impact of similar criteria like BMI and blood pressure that both measure cardiac health. In another approach, individual hazard ratios are added following normalization to ensure consistent treatment across criteria (additive approach). For example, an individual hazard ratio for a particular criterion is divided by a minimum hazard ratio specific to the criterion, then the final hazard ratio for each insured is the theoretical baseline hazard ratio plus an additional amount contributed by each of the criteria over the baseline. However, there is little theory supporting this approach, and the result may not accurately reflect risk.

When more than one criteria is involved in a hazards model, as here, it is found that it is advantageous to include interaction terms. For example, a model including BMI and blood pressure as two criteria should account for the effect of elevated BMI, elevated blood pressure, and elevated BMI and blood pressure together. Because most mortality studies focus on the effect of a single criterion on mortality, interactions between criteria are not captured in the studies. Only a few studies investigating interactions exist. Furthermore, there are no credible medical studies available to quantify interactions between a large number of criteria (e.g., 8, 9, 10, 11, or 12 criteria).

Nevertheless, it is found that best results are obtained by using medical studies that focus on individual criteria hazard ratios, then empirically accounting for interactions between criteria in the determination of a final hazard ratio. In certain embodiments, a combined multiplicative and additive approach results in the most accurate final hazard ratio. For example, consider a 2-criteria model. Let the first hazard ratio be (1+x) and the second hazard ratio be (1+y). The multiplicative approach for the total hazard ratio yields (1+x+y+xy). The additive approach for the total hazard ratio yields (1+x+y). A combined multiplicative and additive approach using an empirically determined weight a yields a total hazard ratio of (1+x+y+α×y). The term α×y represents the interactions between the two criteria, and in the case of more than two criteria, it represents all interactions. The value of α may be solved for by equating the mortality ratios calculated for the knock-out model to mortality experience. For example, relative mortality by risk class and age range is weighted according to the age and risk class distributions in a sample population to obtain risk class mortality assumptions—e.g., a preferred composite, a standard composite, and an aggregate assumption. Ratios of mortality are determined by age, gender, and risk over the aggregate by age and gender. The ratio of the standard composite mortality to preferred composite mortality is then used to solve for α.

Thus, in certain embodiments, where there are a set of criteria for which individual hazard ratios are determined, the final hazard ratio is computed using an overall criteria interaction factor, α, for example, as follows:

Insured's Final Hazard Ratio=α(BMI Hazard Ratio*BP Hazard Ratio* . . . *MVR Hazard Ratio)+(1−α)(BMI Hazard Ratio+BP Hazard Ratio+ . . . +MVR Hazard Ratio−n)

where, among the criteria used are BMI, blood pressure, and motor vehicle record (the periods of ellipsis represent any additional criteria used, which may include other criteria described herein). The number n is the number of criteria considered. (e.g., 5, 6, 7, 8, 9, 10, 11, or 12, for example). Each individual hazard ratio is computed as a hazard rate for insured individual i divided by a baseline hazard rate. In alternative embodiments, the equation above is used to compute the insured's final hazard ratio using factors different from BMI, blood pressure, and motor vehicle record (swapping out those factors in the equation with other factors). Thus, the final hazard ratio can be generalized as follows:

Final Hazard Ratio=α(HR₁*HR₂* . . . *HRₙ)+(1−α)(HR₁+HR₂+ . . . +HRₙ−n)

where n is the number of the plurality of criteria, HRᵢ is hazard ratio for criterion I, and α is the interaction factor.

Furthermore, in certain embodiments, the assigned risk class may be held to within a particular range of the risk class determined by the traditional “knockout” approach described hereinabove. For example, in a particular embodiment, if there are four risk classes available, the risk class assigned based on the final hazard ratio may be restricted to the same class, or one class above, or one class below the class that would be determined via the “knockout” approach. Thus, in this example, if the risk class based on the final hazard ratio, alone, is two or more classes better than the class that would be determined based on the “knockout” approach, the final determined risk class would be one class above the “knockout”-based risk class. Likewise, in this example, if the risk class based on the final hazard ratio, alone, is two or more classes worse than the class that would be determined based on the “knockout” approach, the final determined risk would be one class below the “knockout”-based risk class.

The underwriting decision may be provided for display on a graphical user interface of the underwriter's computing device (216). Additionally, information explaining the underwriting decision may be provided on the display as well. The information may include a comparison of applicant's hazard ratios relative to his/her peers and/or one or more reasons codes that explain the basis for the underwriting decision. Each of the reason codes may correlate to a specific explanation of the underwriting decision.

In some implementations, after providing underwriting decision for display on a graphical user interface of the underwriter's computing device, the system may receive an instruction to overwrite the underwriting decision. The instruction may include an explanation regarding why the underwriting decision is being overwritten. The system may also confirm that the requesting party has the appropriate permission level to overwrite the underwriting decision.

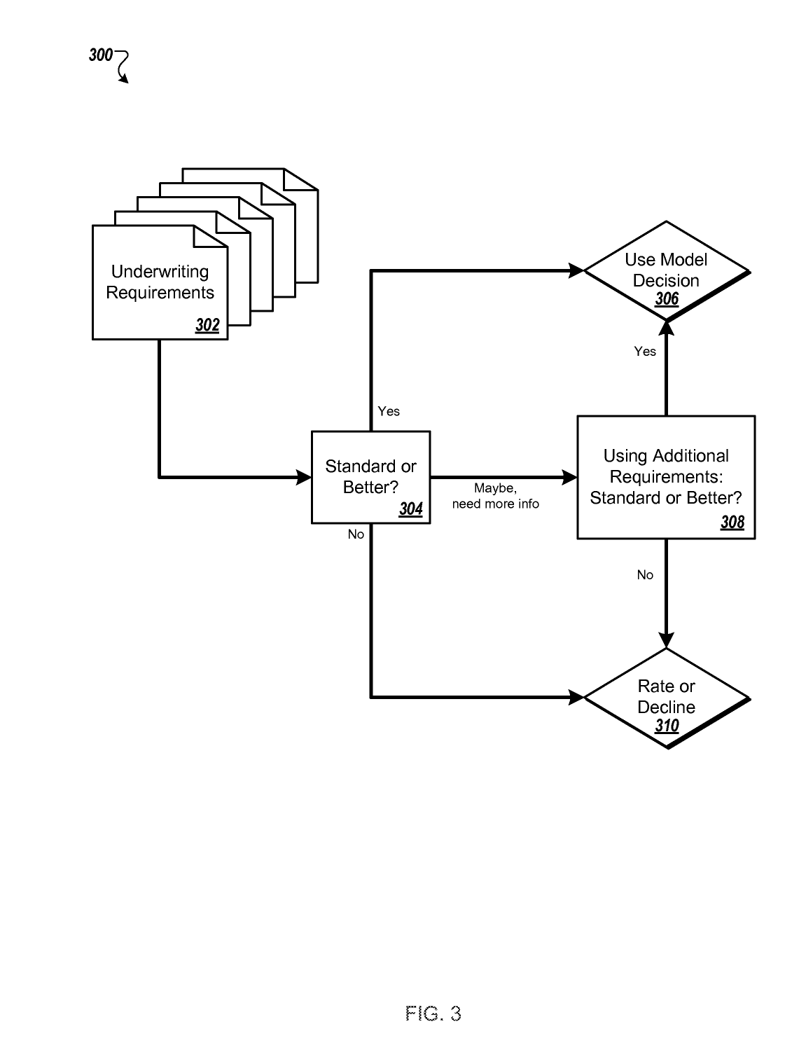

FIG. 3 is an illustration of an example underwriting process for improving efficiency and/or consistency in underwriting decisions. In some implementations, minimum underwriting requirements 302 are received. These requirements may be received by a provider or underwriter. A preliminary assessment 304 is made to determine whether the risk is standard or better. The grading module 306 is used to determine the preferred risk class decision if at any time the risk is standard or better. In some implementations, a secondary review 308 is used if the preliminary assessment 304 requires additional requirements (e.g., for cause requirements). In some implementations, underwriting guidelines/ratings are applied 310 if at any time the risk is identified as being substandard or a decline.

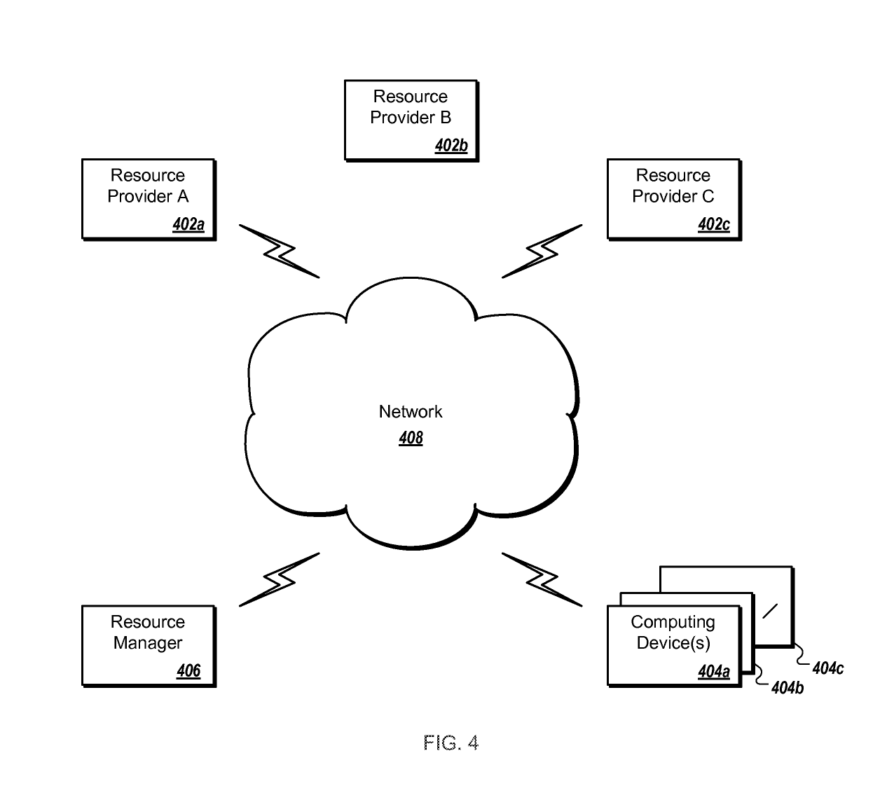

As shown in FIG. 4, an implementation of a network environment 400 for use assessing the eligibility of a customer to receive products and/or services (e.g., equity capital, insurance, mortgage, or credit) from a provider, such as a financial service provider, bank, insurer, or investment house is shown and described. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

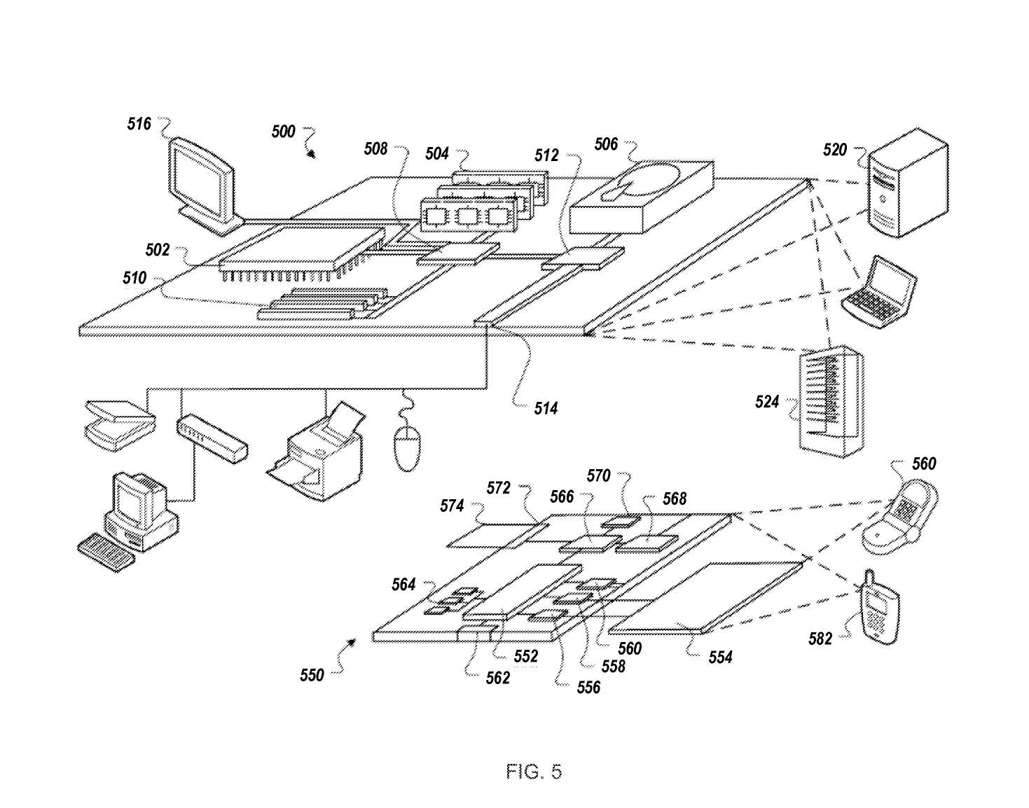

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for assessing the eligibility of a customer to receive products and/or services (e.g., equity capital, insurance, mortgage, or credit) from a provider, such as a financial service provider, bank, insurer, or investment house are provided. Having described certain implementations of methods and apparatus for supporting eligibility assessment, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

1. A method for assessing eligibility for an insurance product using a risk order approach, the method comprising:
receiving, by a processor of a computing device, one or more inputs associated with an applicant for use in determining an underwriting decision;
storing, by the processor, in a database, (i) the one or more inputs and (ii) a unique identifier associated with the applicant and the one or more inputs;
providing, by the processor, for display on a graphical user interface of a second computing device associated with an underwriter, underwriting data, wherein the underwriting data is at least based in part on the one or more inputs;
receiving, by the processor, from the second computing device, a request to determine the underwriting decision;
determining, by the processor, a hazard ratio for each member of a plurality of criteria based at least in part on the underwriting data;
determining, by the processor, a final hazard ratio based at least in part on the hazard ratio for each member of the plurality of criteria;
determining, by the processor, the underwriting decision based at least in part on the final hazard ration; and
providing, by the processor, for display on a graphical user interface of the second computing device, the underwriting decision.

2. The method of claim 1, the method comprising:
after providing underwriting data for display on a graphical user interface of the second computing device, receiving, by the processor, an instruction to overwrite at least a portion of the underwriting data.

3. The method of claim 2, the method comprises:
determining, by the processor, a user associated with the instruction to overwrite at least a portion of the underwriting data satisfies a permission level requirement; and
overwriting, by the processor, at least a portion of the underwriting data.

4. The method of claim 2, the method comprising:
after providing underwriting data for display on a graphical user interface of the second computing device, receiving, by the processor, an explanation for the instruction to overwrite at least a portion of the underwriting data.

5. The method of claim 1, the method comprising:
after providing underwriting decision for display on a graphical user interface of the second computing device, receiving, by the processor, an instruction to overwrite the underwriting decision.

6. The method of claim 5, the method comprising:
after providing underwriting decision for display on a graphical user interface of the second computing device, receiving, by the processor, an explanation for the instruction to overwrite the underwriting decision.

7. The method of claim 1, wherein the one or more inputs comprise at least one member selected from the group consisting of: policy creation date, date of birth, gender, BMI build, blood pressure, motor vehicle record data, non-medical history, tobacco use, personal history, family history, lab results, and health style data.

8. The method of claim 1, wherein the one or more inputs comprise a date of birth, gender, BMI build, blood pressure, motor vehicle record data, non-medical history, tobacco use, personal history, family history, lab results, and health style data.

9. The method of claim 1, wherein the underwriting decision comprises a premium amount and a coverage amount.

10. The method of claim 1, wherein the one or more inputs are received from the second computing device.

11. The method of claim 1, the method comprising:
providing, by the processor, for display on a graphical user interface of the second computing device, information explaining the underwriting decision.

12. The method of claim 11, wherein the information explaining the underwriting decision comprises a comparison of applicant's hazard ration relative to his/her peers.

13. The method of claim 11, wherein the information explaining the underwriting decision comprises one or more reasons codes that explain the basis for the underwriting decision.

14. The method of claim 1, wherein plurality of criteria comprise body mass index, blood pressure, motor vehicle record, family history, personal history, tobacco use, lab results, health style, and non-medical history.

15. The method of claim 1, wherein the underwriting decision identifies a risk class for the applicant.

16. A system for assessing eligibility for an insurance product using a risk order approach, the system comprising:
a memory storing instructions thereon; and
a processor for executing the instructions, wherein the instructions comprise:
receiving one or more inputs associated with an applicant for use in determining an underwriting decision;
storing, in a database, (i) the one or more inputs and (ii) a unique identifier associated with the applicant and the one or more inputs;
providing, for display on a graphical user interface of a second computing device associated with an underwriter, underwriting data, wherein the underwriting data is at least based in part on the one or more inputs;
receiving, from the second computing device, a request to determine the underwriting decision;
determining a hazard ratio for each member of a plurality of criteria based at least in part on the underwriting data;
determining a final hazard ratio based at least in part on the hazard ratio for each member of the plurality of criteria;
determining the underwriting decision based at least in part on the final hazard ration; and
providing, for display on a graphical user interface of the second computing device, the underwriting decision.

17. The system of claim 16, wherein the instructions comprise:
after providing underwriting data for display on a graphical user interface of the second computing device, receiving an instruction to overwrite at least a portion of the underwriting data.

18. The system of claim 17, wherein the instructions comprise:
determining a user associated with the instruction to overwrite at least a portion of the underwriting data satisfies a permission level requirement; and
overwriting at least a portion of the underwriting data.

19. The system of claim 17, wherein the instructions comprise:
after providing underwriting data for display on a graphical user interface of the second computing device, receiving an explanation for the instruction to overwrite at least a portion of the underwriting data.

20. The system of claim 16, wherein the instructions comprise:
after providing underwriting decision for display on a graphical user interface of the second computing device, receiving an instruction to overwrite the underwriting decision.

21-30. (canceled)
